(19) United States
(12) Patent Application Publication
(10) Pub. No.: US 2006/0098811 A1
(43) Pub. Date: May 11, 2006

(54) Telephone-controlled electrical switch device

(76) Inventor: Chi-Wen Chen, Taipei City (TW)

Correspondence Address: FOLEY AND LARDNER LLP;SUITE 500, 3000 K STREET NW, WASHINGTON, DC, 20007, US

(21) Appl. No.: 10/975,844

(22) Filed: Oct. 29, 2004

(51) Int. Cl. H04M 9/00

(52) U.S. Cl. 379/413

(57) ABSTRACT

An electrical switch device includes a housing, a power input unit, a phone jack, a socket receptable, and a switching circuit. The power input unit extends from the housing, and is coupled to a commercial alternating current power source. The phone jack is mounted on the housing, and is coupled to a phone line. The socket receptacle is mounted on the housing, and is coupled to an electrical load. The switching circuit is mounted in the housing, includes a switch and a switch actuator. The switch is coupled between the power input unit and the socket receptacle. The switch actuator is coupled between the phone jack and the switch, and is operable so as to receive a control signal from a calling party through the phone line, and so as to actuate the switch in response to the control signal.

### BACKGROUND OF THE INVENTION

1. Field of the Invention

The invention relates to an electrical switch device, more particularly to a telephone-controlled electrical switch device, which selectively connects and disconnects an electrical load to and from a commercial alternating current power source.

2. Description of the Related Art

A conventional telephone-controlled electrical switch device, which selectively connects and disconnects an electrical load to and from a commercial alternating current power source, includes a housing, a first wiring that extends from the housing and that is connected electrically to a phone line, a second wiring that extends from the housing and that is connected electrically to the commercial alternating current power source, and a third wiring that extends from the housing and that is connected electrically to the electrical load.

Although the conventional telephone-controlled electrical switch device achieves its intended purpose, it is relatively difficult to install. As such, the installation of the conventional telephone-controlled electrical switch can only be performed by trained personnel, thus resulting in high installation costs and poor movability.

### SUMMARY OF THE INVENTION

Therefore, the object of the present invention is to provide a telephone-controlled electrical switch device that is capable of overcoming the aforesaid drawbacks of the prior art.

According to the present invention, an electrical switch device comprises a housing, a power input unit, a phone jack, a socket receptacle, and a switching circuit. The power input unit extends from the housing, and is adapted to be connected electrically and removably to a commercial alternating current power source. The phone jack is mounted on the housing, and is adapted to be connected electrically and removably to a phone line. The socket receptacle is mounted on the housing, and is adapted to be connected electrically and removably to an electrical load. The switching circuit is mounted in the housing, and includes a switch and a switch actuator. The switch is coupled between the power input unit and the socket receptacle, and is operable so as to make or break electrical connection between the power input unit and the socket receptacle. The switch actuator is coupled between the phone jack and the switch, and is operable so as to receive a control signal from a calling party through the phone line, and so as to actuate the switch in response to the control signal.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of an electrical switch device according to the present invention;

FIG. 2 is a schematic circuit block diagram of the preferred embodiment;

FIG. 3 is a schematic circuit diagram of the preferred embodiment;

FIGS. 4A, 4B, and 4C are flowcharts of a method for selectively connecting and disconnecting an electrical load to and from a commercial alternating current power source using the electrical switch device of this invention; and

FIGS. 5A, 5B, and SC are flowcharts of a method for changing the duration of a predetermined time period in the electrical switch device of this invention.

### DETAILED DESCRIPTION OF THE PREFERRED EMBODIMENT

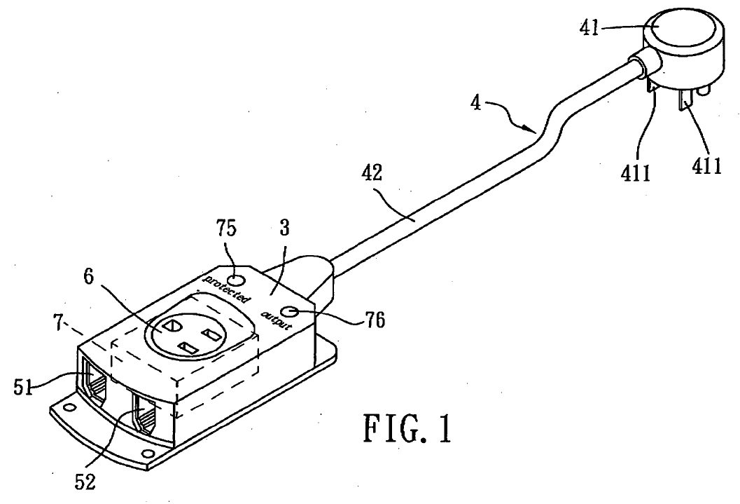

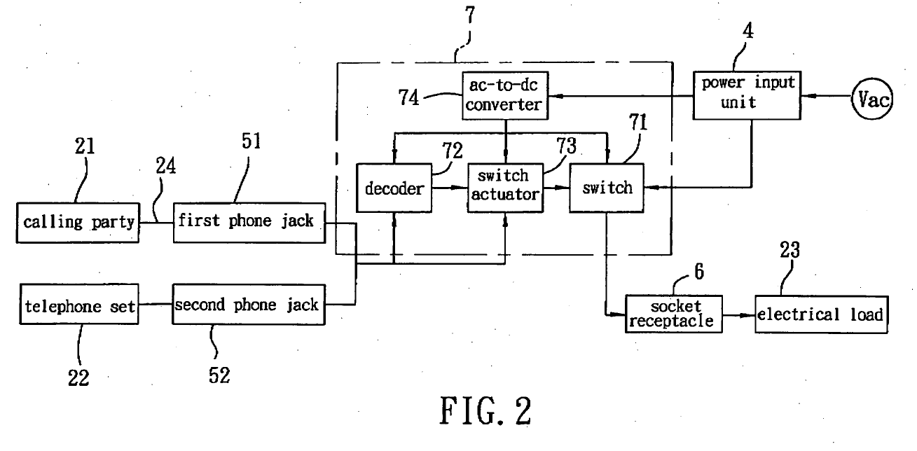

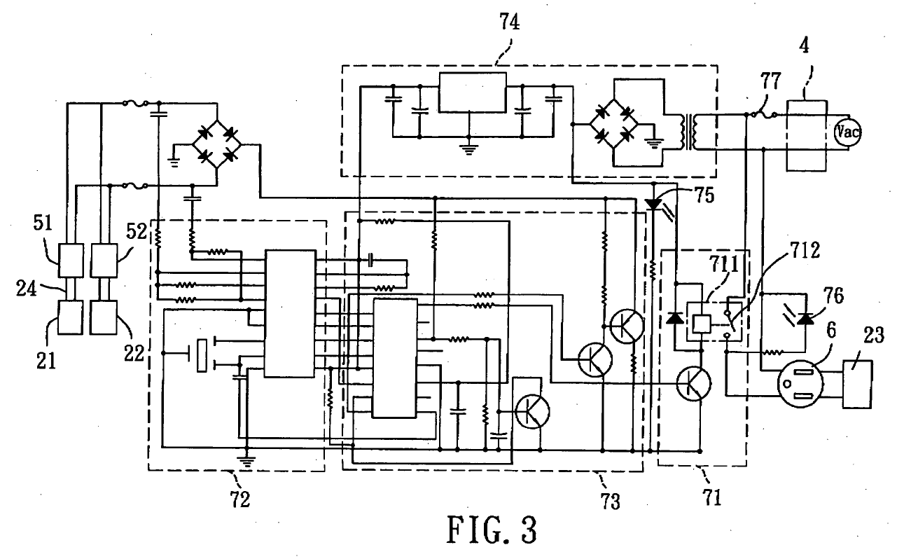

Referring to FIGS. 1 to 3, the preferred embodiment of an electrical switch device according to this invention is shown to include a housing 3, a power input unit 4, a first phone jack 51, a socket receptacle 6, and a switching circuit 7.

The housing 3 is generally rectangular in shape.

The power input unit 4 includes a plug receptacle 41, and an electrical cord 42 that extends from the housing 3 and that is coupled to the plug receptacle 41. The plug receptacle 41 includes prongs 411 that are connected electrically and removably to a commercial alternating current (ac) power source (Vac). In an alternative embodiment, the plug receptacle 41 may be mounted directly on the housing 3, thereby dispensing with the electrical cord.

The first phone jack 51 is mounted on and is accessible from the outside of the housing 3, and is connected electrically and removably to a phone line 24.

The socket receptacle 6 is mounted on and is accessible from the outside of the housing 3, and is connected electrically and removably to an electrical load 23.

The switching circuit 7 is mounted in the housing 3, and includes a switch 71 and a switch actuator 73.

The switch 71 is coupled between the power input unit 4 and the socket receptacle 6, and is operable so as to make or break electrical connection between the power input unit 4, and the socket receptacle 6. In this embodiment, the switch 71 is a relay.

The switch actuator 73 is coupled between the first phone jack 51 and the switch 71, and is operable so as to receive a control signal from a calling party 21 through the phone line 24, and so as to actuate the switch 71 in response to the control signal, in a manner to be described hereinafter. In this embodiment, the switch actuator 73 is implemented in an integrated circuit.

The switching circuit 7 further includes a decoder 72 coupled between the first phone jack 51 and the switch actuator 73, and is operable so as to decode the control signal prior to receipt thereof by the switch actuator 73. In this embodiment, the decoder 72 is implemented in an integrated circuit.

The electrical switch device further includes a status indicator 76 that is mounted on and that is visible from the outside of the housing 3, that is coupled to the switch 71, and that indicates operating state of the switch 71. In this embodiment, the status indicator 76 is a light-emitting diode. Preferably, the status indicator 76 emits a red light.

The switching circuit 7 further includes an alternating current-to-direct current (ac-to-dc) converter 74 that steps down and that converts an ac signal from the commercial ac power source (Vac) to a direct current power signal, which is supplied to the switch 71, the decoder 72, and the switch actuator 73. In this embodiment, the ac-to-dc converter 74 has an input side coupled to the power input unit 4, and an output side coupled to the switch 71, the decoder 72, and the switch actuator 73.

The switching circuit 7 further includes a fuse 77 that protects the electrical switch device from overload. In this embodiment, the fuse 77 is connected electrically between the power input unit 4 and the ac-to-dc converter 74.

The electrical switch device further includes a power indicator 75 that is mounted on and that is visible from the outside of the housing 3, that is coupled to the ac-to-dc converter 74, and that indicates operating state of the fuse 77. In this embodiment, the power indicator 75 is a light-emitting diode. Preferably, the power indicator 75 emits a green light.

The electrical switch device further includes a second phone jack 52 that is mounted on and that is accessible from the outside of the housing 3, that is coupled in parallel to the first phone jack 51, and that is connected electrically and removably to a telephone set 22. In an alternative embodiment, the second phone jack is dispensed with.

The switch actuator 73 is further operable so as to receive the control signal from the telephone set 22 via the second phone jack 52.

The switch actuator 73 is programmed with a first program module for processing the control signal received from the calling party 21 through the phone line 24, and a second program module for processing the control signal received from the telephone set 22.

It is noted that although the electrical switch device of this invention is exemplified using only a pair of phone jacks 51, 52, it should be apparent to those skilled in the art that the number of phone jacks may be increased as required.

Moreover, in an alternative embodiment, the electrical switch device includes a plurality of the socket receptables 6 that are connected electrically and removably to a plurality of electrical loads, respectively. The switching circuit 7 includes a plurality of independently-controllable switches 71, each of which is coupled between the power input unit 4 and a respective one of the socket receptacles 6.

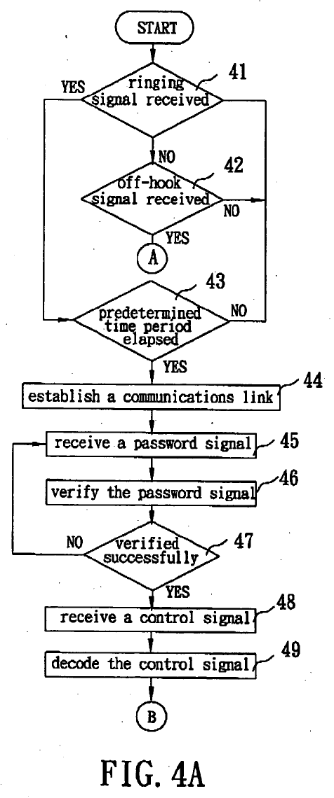

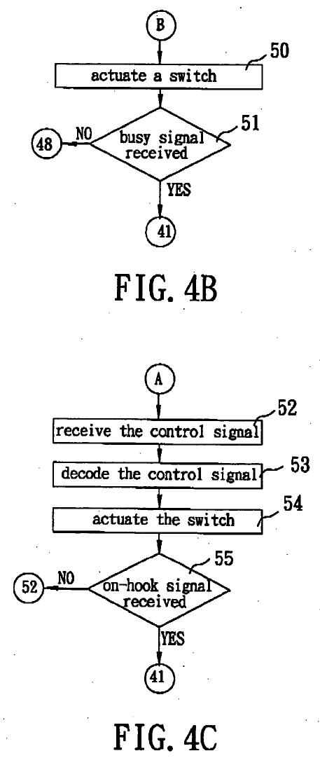

A method for selectively connecting and disconnecting the electrical load 23 to and from the commercial ac power source (Vac) using the preferred embodiment of the electrical switch device of this invention includes the steps shown in FIGS. 4A, 4B, and 4C.

In step 41, when the switch actuator 73 receives a ringing signal through the phone line 24, i.e., the calling party 21 initiates a call through the phone line 24, the flow proceeds to step 43.

In step 42, when the switch actuator 73 receives an off-hook signal, i.e., the telephone set 22 is lifted from its cradle, the flow proceeds to step 52. Otherwise, the flow goes back to step 41.

In step 43, the switch actuator 73 checks whether the ringing signal is continuously received for a predetermined time period. If yes, the flow proceeds to step 44. Otherwise, the flow goes back to step 41.

It is noted that, in this embodiment, the switch actuator 73 is further operable so as to receive a setting signal from the calling party 21 through the phone line 24, or from the telephone set 22 via the second phone jack 52, and so as to change the duration of the predetermined time period in response to the setting signal, in a manner to be described hereinafter.

In step 44, the switch actuator 73 establishes a communications link with the calling party 21 through the phone line 24.

In step 45, the switch actuator 73 receives a password signal transmitted by the calling party 21 through the phone line 24.

It is noted that, in this embodiment, the password signal includes dual tone multi frequency (DTMF) tones that are generated by the calling party 21 in a manner known in the art.

In step 46, the switch actuator 73 verifies the password signal.

In step 47, when the switch actuator 73 successfully verifies the password signal, the flow proceeds to step 48. Otherwise, the flow goes back to step 45 to enable the calling party 21 to provide a new password signal.

In step 48, the switch actuator 73 receives the control signal from the calling party 21 through the phone line 24.

It is noted that, in this embodiment, the control signal includes DTMF tones.

In step 49, the decoder 72 decodes the control signal transmitted by the calling party 21 through the phone line 24.

In step 50, the switch actuator 73 actuates the switch 71 in response to the control signal decoded by the decoder 72.

As an example, if the control signal includes a the switch actuator 73 energizes the switch 71, whereby, the socket receptacle 6 is connected to the power input unit 4, thereby permitting flow of an ac power signal to the electrical load 23. In addition, if the control signal includes a “*”, the switch actuator 73 de-energizes the switch 71, whereby, the socket receptacle 6 is disconnected from the power input unit 4, thereby interrupting the flow of an ac power signal to the electrical load 23.

In step 51, when the switch actuator 73 receives a busy signal through the phone line 24, i.e., the calling party 21 disconnected the communications link, the flow goes back to step 41. Otherwise, the flow goes back to step 48 to enable the calling party 21 to provide a new control signal.

In step 52, the switch actuator 73 receives the control signal from the telephone set 22 via the second phone jack 52.

In step 53, the decoder 72 decodes the control signal.

In step 54, the switch actuator 73 actuates the switch 71 in response to the control signal decoded by the decoder 72.

In step 55, when the switch actuator 73 receives an on-hook signal, i.e., the telephone set 22 is replaced on its cradle, the flow goes back to step 41. Otherwise, the flow goes back to step 52 to enable the telephone set 22 to provide a new control signal.

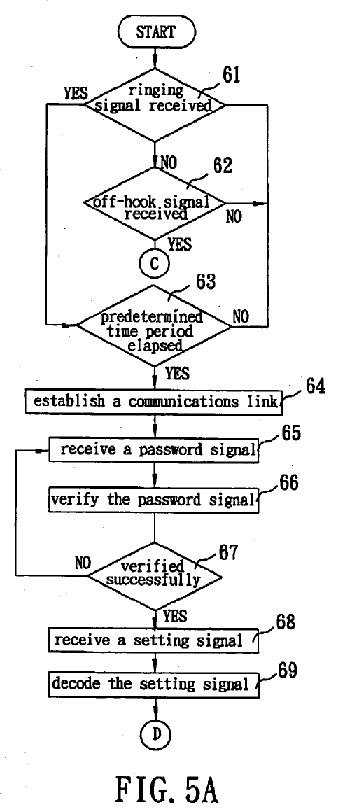

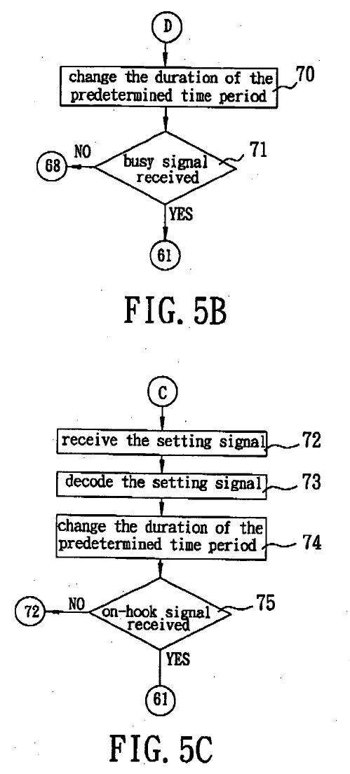

A method for setting the duration of the predetermined time period includes the steps shown in FIGS. 5A, 5B, and 5C.

In step 61, when the switch actuator 73 receives the ringing signal through the phone line 24, i.e., the calling party 21 initiates a call through the phone line 24, the flow proceeds to step 63.

In step 62, when the switch actuator 73 receives an off-hook signal, i.e., the telephone set 22 is lifted from its cradle, the flow proceeds to step 72. Otherwise the flow goes back to step 61.

In step 63, the switch actuator 73 checks whether the ringing signal is continuously received for the predetermined time period. If yes, the flow proceeds to step 64. Otherwise, the flow goes back to step 61.

In step 64, the switch actuator 73 establishes a communications link with the calling party 21 through the phone line 24.

In step 65, the switch actuator 73 receives the password signal transmitted by the calling party 21 through the phone line 24.

In step 66, the switch actuator 73 verifies the password signal.

In step 67, when the switch actuator 73 successfully verifies the password signal, the flow proceeds to step 68. Otherwise, the flow goes back to step 65 to enable the calling party 21 to provide a new password signal.

In step 68, the switch actuator 73 receives the setting signal from the calling party 21 through the phone line 24.

It is noted that, in this embodiment, the setting signal includes DTMF tones.

In step 69, the decoder 72 decodes the setting signal transmitted by the calling party 21 through the phone line 24.

In step 70, the switch actuator 73 changes the duration of the predetermined time period in response to the setting signal decoded by the decoder 72.

As an example, if the setting signal includes a “#” followed by a “*”, the duration of the predetermined time period is changed to 3 seconds. In addition, if the setting signal includes a pair of “#”, the duration of the predetermined time period is changed to 40 seconds.

In step 71, when the switch actuator 73 receives a busy signal through the phone line 24, i.e., the calling party 21 disconnected the communications link, the flow goes back to step 61. Otherwise, the flow goes back to step 68 to enable the calling party 21 to provide a new setting signal.

In step 72, the switch actuator 73 receives the setting signal from the telephone set 22 via the second phone jack 52.

In step 73, the decoder 72 decodes the setting signal.

In step 74, the switch actuator 73 changes the duration of the predetermined time period in response to the setting signal.

In step 75, when the switch actuator 73 receives an on-hook signal, i.e., the telephone set 22 is replaced on its cradle, the flow goes back to step 61. Otherwise, the flow goes back to step 72 to enable the telephone set 22 to provide a new control signal.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An electrical switch device comprising:
a housing;
a power input unit extending from said housing, and adapted to be connected electrically and removably to a commercial alternating current power source;
a first phone jack mounted on said housing, and adapted to be connected electrically and removably to a phone line;
a socket receptacle mounted on said housing, and adapted to be connected electrically and removably to an electrical load; and
a switching circuit mounted in said housing, and including
a switch coupled between said power input unit and said socket receptacle, and operable so as to make or break electrical connection between said power input unit and said socket receptacle, and
a switch actuator coupled between said first phone jack and said switch, and operable so as to receive a control signal from a calling party through the phone line, and so as to actuate said switch in response to the control signal.

2. The electrical switch device as claimed in claim 1, wherein said switching circuit further includes a decoder coupled between said first phone jack and said switch actuator, and operable so as to decode the control signal prior to receipt thereof by said switch actuator.

3. The electrical switch device as claimed in claim 1, further comprising a second phone jack mounted on said housing, coupled in parallel to said first phone jack, and adapted to be connected electrically and removably to a telephone set, said switch actuator being further operable so as to receive the control signal from the telephone set.

4. The electrical switch device as claimed in claim 1, wherein said switching circuit further includes a fuse connected to said power input unit.

5. The electrical switch device as claimed in claim 4, further comprising a power indicator mounted on said housing for indicating operating state of said fuse.

6. The electrical switch device as claimed in claim 1, further comprising a status indicator mounted on said housing and coupled to said switch for indicating operating state of said switch.

7. The electrical switch device as claimed in claim 1, wherein said switch is a relay.

8. The electrical switch device as claimed in claim 2, wherein said switching circuit further includes an alternating current-to-direct current (ac-to-dc) converter coupled to said power input unit for supplying a direct current power signal to said switch, said decoder, and said switch actuator.

9. The electrical switch device as claimed in claim 1, wherein said switch actuator is further operable so as to receive a ringing signal through the phone line prior to receipt of the control signal, and so as to establish a communications link with the calling party through the phone line when the ringing signal is continuously received by said switch actuator for a predetermined time period.
